(19) United States
(12) Patent Application Publication
(10) Pub. No.: US 2003/0060315 A1
(43) Pub. Date: Mar. 27, 2003

(54) Chain guide device for bicycles

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/963,028

(22) Filed: Sep. 26, 2001

(51) Int. Cl. F16H 7/12; F16H 55/36; F16H 55/12

(52) U.S. Cl. 474/141; 474/160; 474/134

(57) ABSTRACT

A bicycle chain guide device includes a plate mounted to the crank axle has two protrusions and each of the protrusions has a first roller and a second roller connected thereto. The chain engaged with a chainwhell passes between the first roller and the second roller on each of the two protrusions.

### FIELD OF THE INVENTION

The present invention relates to a bicycle chain guide device having two pairs of rollers and the chain is movably retained between the two rollers.

### BACKGROUND OF THE INVENTION

A first conventional bicycle chain guide device 10 is shown in FIGS. 1 and 2, and generally includes two rollers 14 connected on two of three protrusions 13 of a three-protrusion member 11 which is fixedly mounted on an axle 18 of the bottom bracket. Each of the rollers 14 has a groove 141 so that the chain 19 is engaged with the groove 141 of each of the rollers 14. A chainwheel is mounted to the axle 18 and engaged with the chain 19. A crank 15 is fixedly connected to the axle 18 so that the chainwheel 17 is rotated when rotating the crank 15 and the chain 19 is driven by the rotation of the chainwheel 17. The chain 19 is supposed to be received in the grooves 141, however, the tension makes the chain 19 shake between the chainwheel 17 and the rollers 14. The chain 19 could jump out from the grooves 141 and the disengaged from the teeth 171 of the chain wheel 17.

A second conventional bicycle chain guide device 20 is shown in FIGS. 3 and 4, and generally includes two tunnel members 211 connected on two ends of a plate 21 and the plate 21 is mounted on the axle 23 by a support ring 22 fixed on the axle 23 and the plate 21. The chain 27 extends through two tunnel members 211 and is engaged with teeth 261 of the chainwheel 26. The chain 27 is retained in the two tunnel members 211. However, the chain 27 is quickly worn out because the frequent contact to the tunnel members 211.

### SUMMARY OF THE INVENTION

In accordance with one aspect of the present invention, there is provided a bicycle chain guide device which comprises a plate mounted to a crank axle and the plate has two protrusions. Each of the protrusions has a first roller and a second roller connected thereto. The chain passes between the first roller and the second roller on each of the two protrusions.

The primary object of the present invention is to provide a chain guide device that includes two pairs of rollers on two protrusions of a plate mounted to the crank axle, and the chain is retained between the rollers.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first conventional bicycle chain guide device;

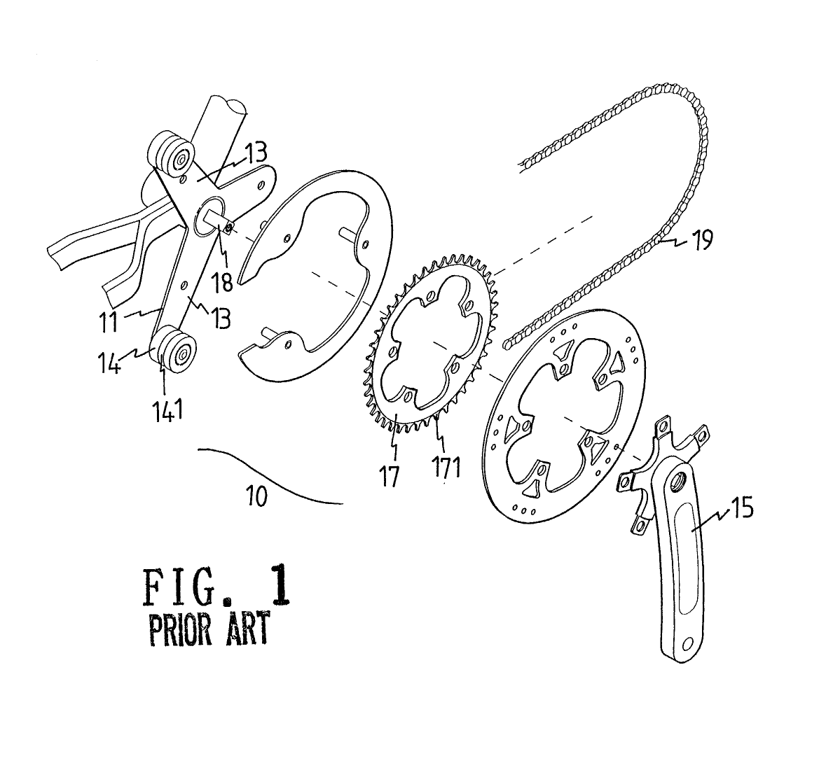

FIG. 2 is a side view to show the first conventional bicycle chain guide device;

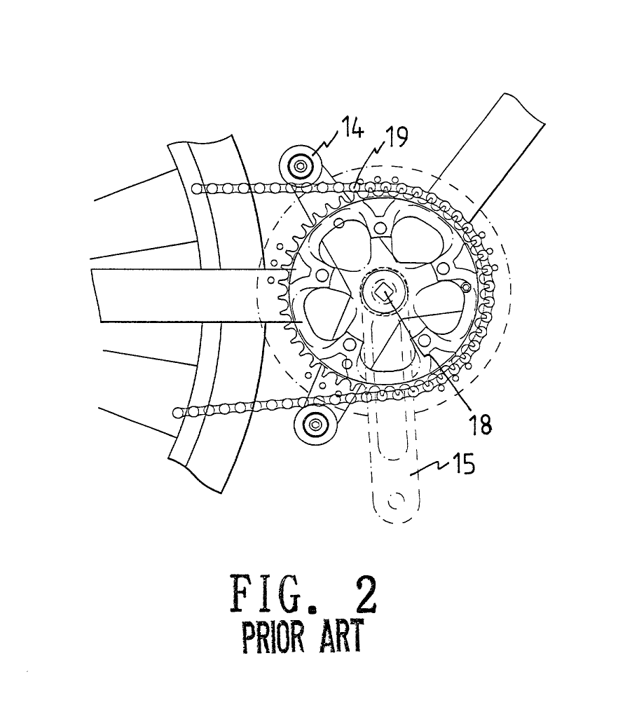

FIG. 3 is an exploded view to show a second conventional bicycle chain guide device;

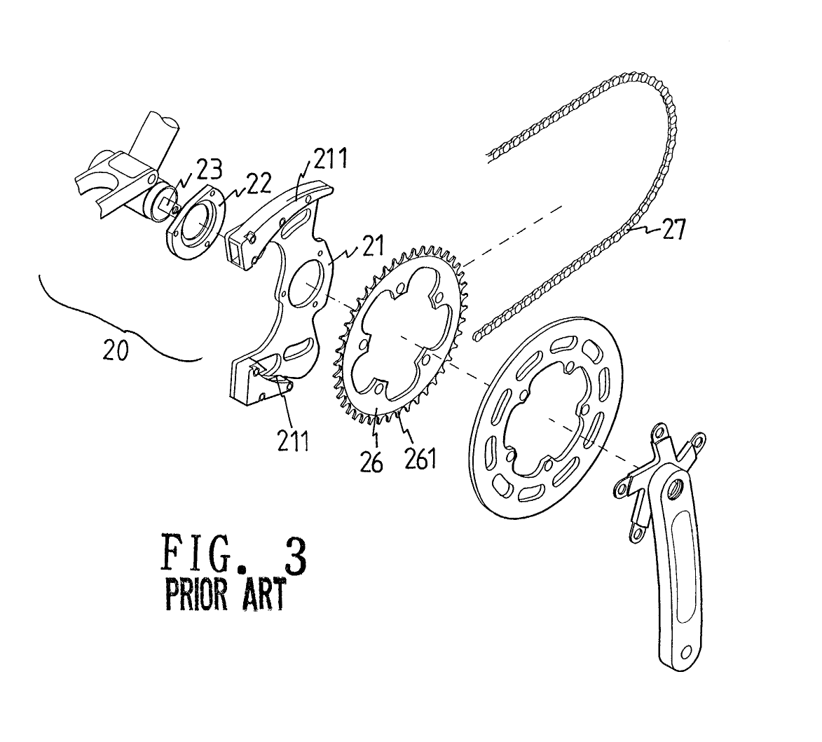

FIG. 4 is a side view to show the second conventional bicycle chain guide device;

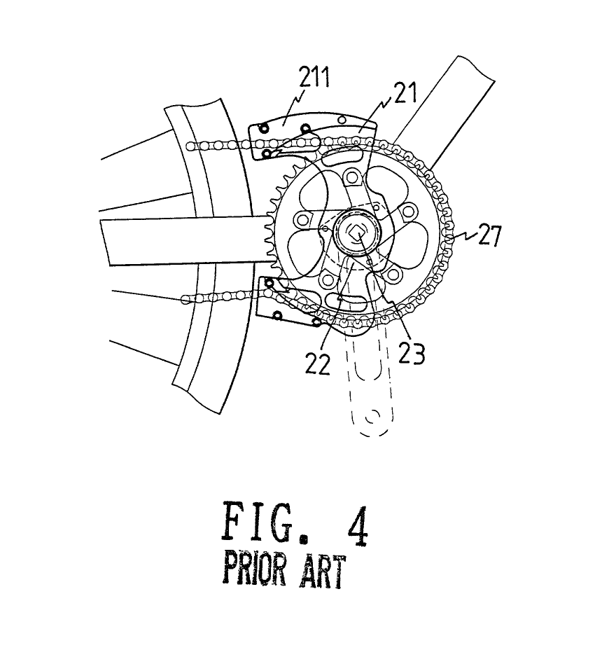

FIG. 5 is an exploded view to show the bicycle chain guide device of the present invention;

FIG. 6 is an exploded view to show the bicycle chain guide device of the present invention wherein the rollers are connected to the plate;

FIG. 7 is a side view to show the bicycle chain guide device of the present invention, and

FIG. 8 is an illustrative view to show the width of the groove in the rollers of the bicycle chain guide device of the present invention is different.

### DETAILED DESCRIPTION OF THE PREFERRED EMBODIMENT

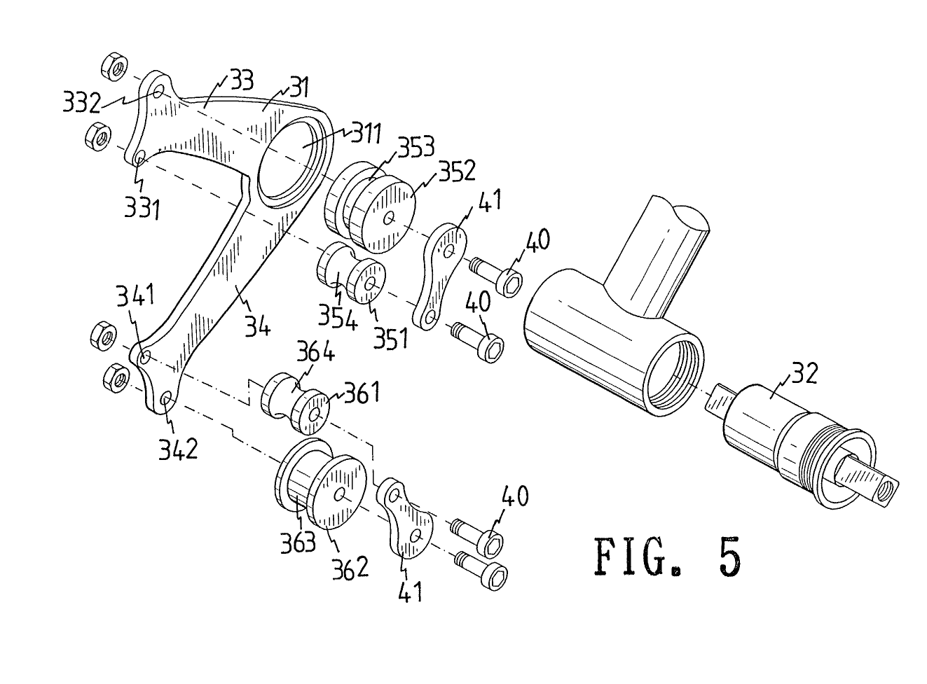

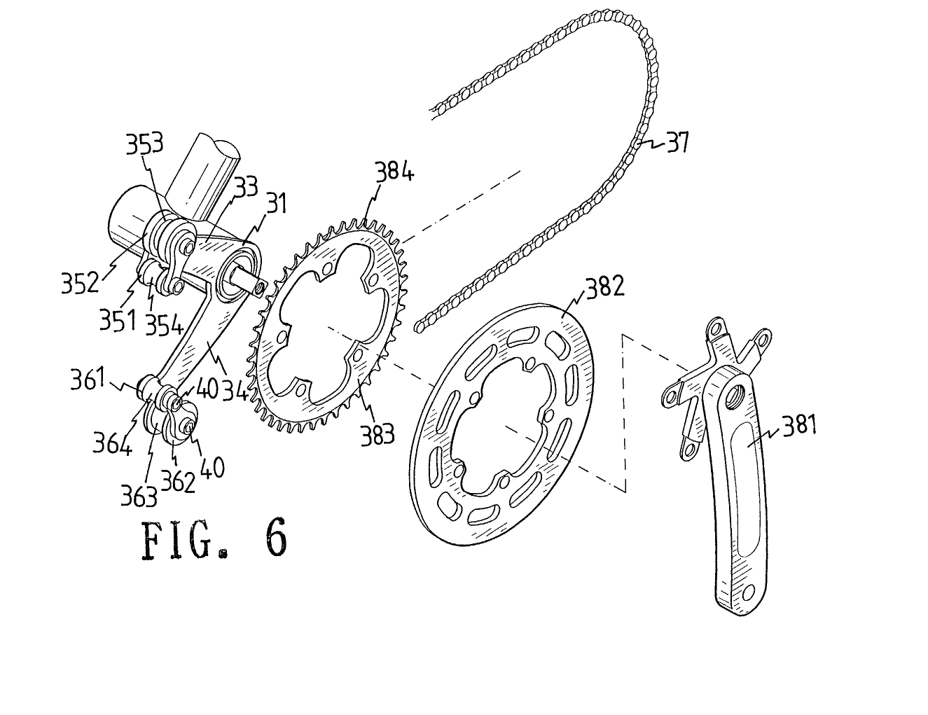

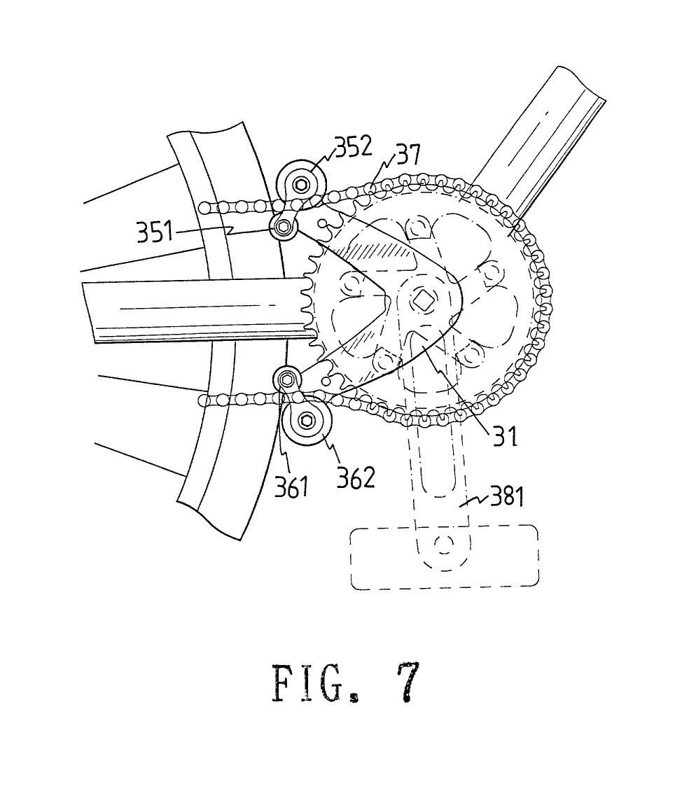

Referring to FIGS. 5 to 7, the bicycle chain guide device of the present invention comprises a plate 31 mounted to a crank axle 32 and having two protrusions 33, 34. The protrusion 33 has two holes 331, 332 defined therethrough so that a first roller 351 and a second roller 352 are connected to the protrusion 33 by two bolts 40 and a fixing plate 41. The protrusion 34 has two holes 341, 342 defined therethrough so that a third roller 361 and a fourth roller 362 are connected to the protrusion 34 by two bolts 40 and a fixing plate 41. The first roller 351 has a groove 354 and the second roller 352 has a groove 353 defined in an outer periphery thereof. The third roller 361 has a groove 364 and the fourth roller 362 has a groove 363 defined in an outer periphery thereof.

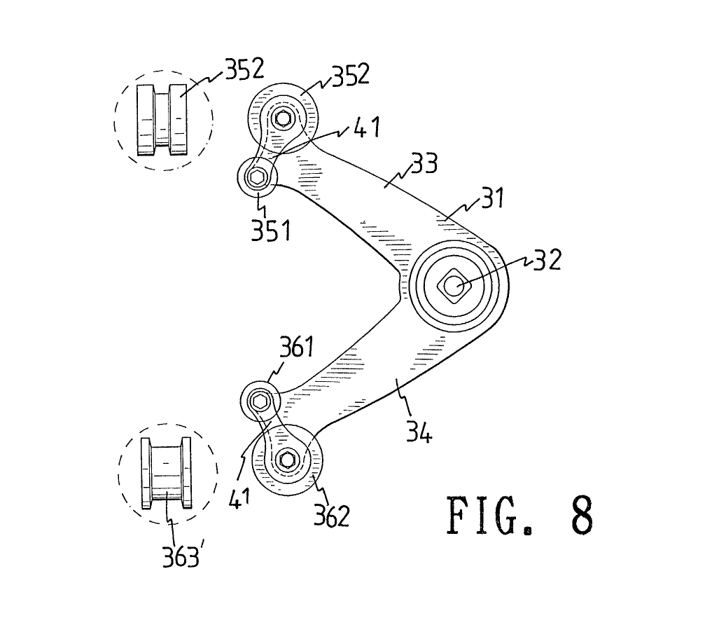

A chainwheel 383 and a cap 382 are respectively mounted to the crank axle 32, and a crank 381 is fixed to each end of the crank axle 32. A chain 37 is engaged with the teeth 384 of the chainwheel 383 and passes between the first roller 351 and the second roller 352 on the protrusion 33, and between the third roller 361 and the fourth roller 362 on the protrusion 34. The chain 37 is then retained between the grooves 353, 354 and 363, 364. Referring to FIG. 8, it is noted that the tension on the upper section of the chain 37 is often larger than the lower section of the chain 37, so that the grooves 354, 353 in the first roller 351 and the second roller 352 on the protrusion 33 are smaller than the grooves 364, 363 in the third roller 361 and the fourth roller 362 on the protrusion 34. By the wider grooves 363, 364, the lower section of the chain 37 with less tension can be effectively retained in the grooves 363, 364 and reduces the possibility of disengagement with the chainwheel 383.

The chain 37 is maintained in its operation position by the rollers 351, 352, 361 and 362 so that the chain 37 will no skip or disengage from the chainwheel 383.

While we have shown and described the embodiment in accordance with the present invention, it should be clear to those skilled in the art that further embodiments may be made without departing from the scope of the present invention.

What is claimed is:

1. A bicycle chain guide device comprising:
a plate having two protrusions and adapted to be mounted to a crank axle, each of said protrusions having a first roller and a second roller connected thereto, a chain passing between said first roller and said second roller on each of said two protrusions.

2. The device as claimed in claim 1, wherein each of said first rollers and each of said second rollers have a groove defined in an outer periphery thereof.

3. The device as claimed in claim 2, wherein said grooves in said first roller and said second roller on one of said two protrusions are smaller than said grooves in said first roller and said second roller on the other protrusion of said plate.
